(19) United States
(12) Patent Application Publication
(10) Pub. No.: US 2021/0213868 A1
(43) Pub. Date: Jul. 15, 2021

(54) LAMP CONTROL APPARATUS FOR VEHICLE

(71) Applicant: HYUNDAI MOBIS CO., LTD., Seoul (KR)

(72) Inventor: Jun Young SUNG, Yongin-si (KR)

(21) Appl. No.: 17/133,430

(22) Filed: Dec. 23, 2020

(30) Foreign Application Priority Data
Jan. 14, 2020 (KR) 10-2020-0004783

(51) Int. Cl. B60Q 1/08; H05B 47/125

(52) U.S. Cl. CPC B60Q 1/08; H05B 47/125

(57) ABSTRACT

The present disclosure relates to a lamp control apparatus, and may include an object detection device for detecting an object at a periphery of the vehicle to output the detection result as object information and a light pattern output device for determining whether a preceding vehicle driving on a host lane is present, based on the object information and to generate light pattern information for changing a light pattern depending on the determination result.

### CROSS-REFERENCE TO RELATED APPLICATION

This application claims the benefit of priority to Korean Patent Application No. 10-2020-0004783, filed in the Korean Intellectual Property Office on Jan. 14, 2020, the entire contents of which are incorporated herein by reference.

### TECHNICAL FIELD

The present disclosure relates to a lamp control apparatus for controlling a light irradiation range of a head lamp disposed in a vehicle.

### BACKGROUND

In general, beam patterns implemented in the head lamp of a vehicle are roughly divided into a low beam and a high beam.

The high beam pattern technology forms a shadow zone when a preceding vehicle appears while a host vehicle always is driving in a high beam mode, and thus provides the driver of the host vehicle with a comfortable view while preventing the driver of the other vehicle from causing glare.

In general, the high beam pattern technology is identically applied to all of driver driving, Advanced Driver Assistance Systems (ADAS) driving, and autonomous driving.

Because a driver depends on the driver's field of view while the driver drives a vehicle directly, the high beam pattern technology may be effective. However, the power generating a high beam pattern may be consumed inefficiently because the driver does not depend on the driver's field of view during ADAS driving and autonomous driving.

### SUMMARY

The present disclosure has been made to solve the above-mentioned problems occurring in the prior art while advantages achieved by the prior art are maintained intact.

An aspect of the present disclosure provides a lamp control apparatus for a vehicle capable of changing a light irradiation pattern depending on a driving mode.

An aspect of the present disclosure provides a lamp control apparatus for a vehicle capable of changing a light irradiation pattern depending on whether there is a preceding vehicle during ADAS driving or autonomous driving.

An aspect of the present disclosure provides a lamp control apparatus for a vehicle capable of changing a light irradiation distance and a light width depending on the distance to a preceding vehicle during ADAS driving or autonomous driving.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a lamp control apparatus for a vehicle may include an object detection device for detecting an object at a periphery of the vehicle to output the detection result as object information and a light pattern output device for determining whether a preceding vehicle driving on a host lane is present, based on the object information and to generate light pattern information for changing a light pattern depending on the determination result.

According to an aspect of the present disclosure, a lamp control apparatus for a vehicle may include a selection device for generating a pattern selection signal based on a driving mode signal, an object detection device for detecting an object at a periphery of the vehicle to output the detection result as object information, a first light pattern output device for generating light pattern information based on the pattern selection signal, and a second light pattern output device for generating the light pattern information based on the pattern selection signal and the object information.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating a configuration of a lamp control apparatus for a vehicle according to an embodiment of the present disclosure;

FIG. 2 is a diagram illustrating an embodiment of a second light pattern output device of a lamp control apparatus for a vehicle according to an embodiment of the present disclosure;

FIG. 3 is a flowchart illustrating an operation of a lamp control apparatus for a vehicle according to an embodiment of the present disclosure; and

FIGS. 4A to 4C are views illustrating a light irradiation pattern of a lamp control apparatus for a vehicle according to an embodiment of the present disclosure.

### DETAILED DESCRIPTION

Hereinafter, exemplary embodiments of the present disclosure will be described in detail with reference to the accompanying drawings. In the drawings, the same reference numerals will be used throughout to designate the same or equivalent elements. In addition, a detailed description of well-known features or functions will be ruled out in order not to unnecessarily obscure the gist of the present disclosure.

In describing elements of exemplary embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which this invention belongs. It will be understood that terms used herein should be interpreted as having a meaning that is consistent with their meaning in the context of the present disclosure and the relevant art and will not be interpreted in an idealized or overly formal sense unless expressly so defined herein.

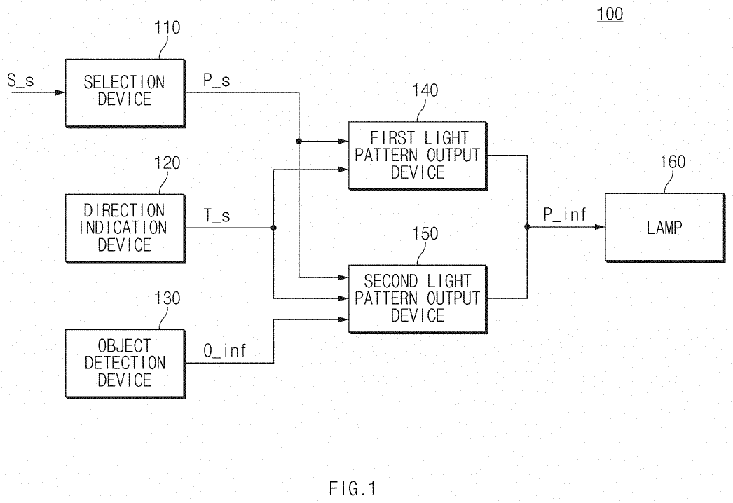

Hereinafter, various embodiments of the present disclosure will be described in detail with reference to FIGS. 1 to 4.

FIG. 1 is a diagram illustrating a configuration of a lamp control apparatus for a vehicle according to an embodiment of the present disclosure.

Referring to FIG. 1, a lamp control apparatus 100 for vehicle according to an embodiment of the present disclosure may be implemented inside a vehicle. At this time, the lamp control apparatus 100 for vehicle may be integrally formed with internal control units of the vehicle; the lamp control apparatus 100 for vehicle may be implemented as a separate apparatus to be connected to the control units of the vehicle by a separate connection means.

Referring to FIG. 1, the lamp control apparatus 100 for vehicle according to an embodiment of the present disclosure may include a selection device 110, a direction indication device 120, an object detection device 130, a first light pattern output device 140, a second light pattern output device 150, and a lamp 160.

The selection device 110 may generate a pattern selection signal P_s based on a driving mode selection signal S_s. At this time, the driving mode selection signal S_s may refer to a signal generated when a driver selects the driving mode of a vehicle, and may be a signal that is disabled in a driver driving mode where the driver directly drives a vehicle, and is enabled in semi-autonomous driving (e.g., ADAS driving) or autonomous driving.

For example, when the driving mode selection signal S_s is enabled, the selection device 110 may enable the pattern selection signal P_s; when the driving mode selection signal S_s is disabled, the selection device 110 may disable the pattern selection signal P_s.

The direction indication device 120 may include a turn signal device that displays the driving direction of a vehicle by the manipulation of a driver.

For example, when the driver changes the driving direction of the vehicle to the left, the direction indication device 120 may enable the direction indication signal T_s; when the driver changes the driving direction of a vehicle to the right, the direction indication device 120 may disable the direction indication signal T_s.

The object detection device 130 may include a device and a sensor that detect an object positioned around a vehicle.

For example, the object detection device 130 may include at least one of an optical camera, an infrared camera, radar, or Li DAR.

When the object detection device 130 includes at least one of an optical camera or an infrared camera, the object detection device 130 may obtain image information from an image regarding the periphery of the vehicle and may output the image information as object information O_inf.

In the meantime, when the object detection device 130 includes at least one of radar or LiDAR, the object detection device 130 may detect an object around the vehicle and may output the distance between the detected object and the vehicle, a relative speed, and a location as the object information O_inf.

Besides, the object detection device 130 may include at least one of an optical camera or an infrared camera and includes at least one of radar or LiDAR, the object detection device 130 may output image information, information about a distance to an object, information about a relative speed with the object, and location information of the object as the object information O_inf.

The first light pattern output device 140 may receive the pattern selection signal P_s from the selection device 110 and may receive the direction indication signal T_s from the direction indication device 120.

When the pattern selection signal P_s is disabled, the first light pattern output device 140 may be activated to generate light pattern information P_inf based on the direction indication signal T_s. Meanwhile, when the pattern selection signal P_s is enabled, the first light pattern output device 140 may be deactivated.

For example, when the pattern signal P_s is disabled, the first light pattern output device 140 may generate the light pattern information P_inf such that the lamp 160 emits light at a predetermined light irradiation distance and wide width. At this time, when the direction indication signal T_s is enabled, the first light pattern output device 140 may output the light pattern information P_inf that enhances (or increases) the left light width of the light pattern emitted from the lamp 160. In the meantime, when the direction indication signal T_s is disabled, the first light pattern output device 140 may output the light pattern information P_inf that enhances (or increases) the right light width of the light pattern emitted from the lamp 160.

The second light pattern output device 150 may receive the pattern selection signal P_s from the selection device 110, may receive the direction indication signal T_s from the direction indication device 120, and may receive the object information O_inf from the object detection device 130.

The second light pattern output device 150 may generate the light pattern information P_inf based on the pattern selection signal P_s, the direction indication signal T_s, and the object information O_inf.

For example, when the pattern selection signal P_s is enabled, the second light pattern output device 150 may be activated to generate the light pattern information P_inf based on the object information O_inf and the direction indication signal T_s. In the meantime, when the pattern selection signal P_s is disabled, the second light pattern output device 150 may be deactivated.

When the pattern selection signal P_s is disabled, the second light pattern output device 150 may determine whether there is a preceding vehicle driving on a host lane, based on the object information O_inf and may generate the light pattern information P_inf for changing the light irradiation distance and light width depending on the distance from the preceding vehicle. At this time, as the distance to the preceding vehicle is shorter, the second light pattern output device 150 may generate the light pattern information P_inf that allows the light irradiation distance to be shortened.

The second light pattern output device 150 may generate the light pattern information P_inf such that a light pattern with a light width smaller than the light width formed depending on the light pattern information P_inf output from the first light pattern output device 150 is formed.

Furthermore, when the pattern selection signal P_s is disabled and when it is determined based on the object information O_inf that there is no preceding vehicle within a predetermined distance, the second light pattern output device 150 may generate the light pattern information P_inf that allows the lamp 160 to emit a light pattern having a minimum light width and a maximum light irradiation distance.

The lamp 160 may include a device that emits light onto a road with a light pattern according to the light pattern information P_inf.

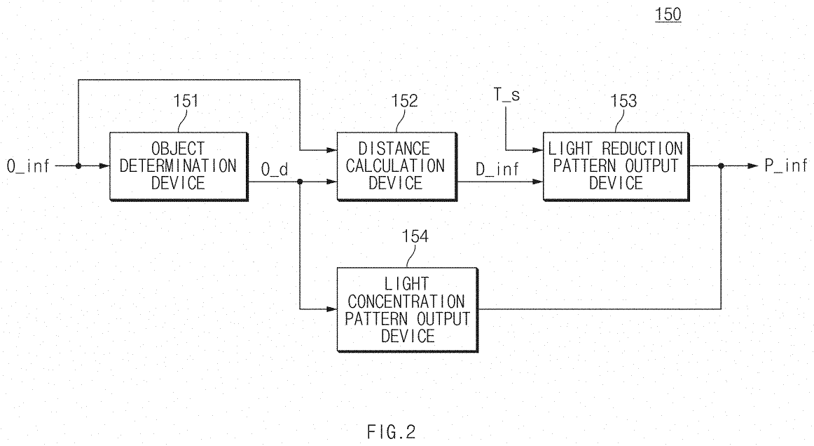

FIG. 2 is a diagram illustrating an embodiment of a second light pattern output device of a lamp control apparatus for a vehicle according to an embodiment of the present disclosure.

Referring to FIG. 2, the second light pattern output device 150 may include an object determination device 151, a distance calculation device 152, a light reduction pattern output device 153, and a light concentration pattern output device 154.

The object determination device 151 may generate an object detection signal O_d by determining whether an object is present within a predetermined distance, based on the object information O_inf.

For example, when it is determined based on the object information O_inf that an object driving on the host lane is present within a predetermined distance, the object determination device 151 may enable the object detection signal O_d. At this time, the object determination device 151 may receive the object information O_inf provided from the radar or LiDAR detecting the front of the vehicle. Also, the object determination device 151 may receive object the information O_inf from an optical camera that provides the front image of a vehicle as image information.

In the meantime, when it is determined based on the signal of the object information O_inf that the object driving on the host lane is not present within a predetermined distance, the object determination device 151 may disable the object detection signal O_d.

As a result, the object determination device 151 may be a configuration that determines whether there is an object (i.e., a preceding vehicle) within a predetermined distance while driving on the host lane, the object determination device 151 may output the determination result as the object detection signal O_d.

The distance calculation device 152 may calculate a distance to the detected object based on at least one of the object detection signal O_d of the object determination device 151 or the object information O_inf and may output the calculated result as distance information D_inf.

For example, when the object detection signal O_d is enabled, the distance calculation device 152 may calculate the distance to an object (e.g., a preceding vehicle) based on the object information O_inf and may output the calculation result as the distance information D_inf.

When the object detection signal O_d is enabled, the distance calculation device 152 may generate the distance information D_inf including a signal, of which the voltage level or current amount is changed depending on the distance to an object, based on the object information O_inf.

When the object detection signal O_d is enabled, the distance calculation device 152 may increase the voltage level of a signal included in the distance information D_inf or the current amount of the signal, based on the object information O_inf as the distance to the object is shorter.

Meanwhile, when the object detection signal O_d is enabled, the distance calculation device 152 may generate the distance information D_inf including a code of which the code value is changed depending on a distance to the object, based on the object information O_inf.

When the object detection signal O_d is enabled, the distance calculation device 152 may increase the code value of the code included in the distance information D_inf, based on the object information O_inf as the distance to the object is shorter.

As a result, when the enabled object detection signal O_d indicating that an object (e.g., a preceding vehicle) is present within a predetermined distance is entered, the distance calculation device 152 may change the distance information D_inf depending on the a distance to the preceding vehicle, based on the object information O_inf.

Hereinafter, it is assumed that the distance calculation device 152 generates the distance information D_inf having a code value.

The light reduction pattern output device 153 may generate light pattern information P_inf, based on the distance information D_inf of the distance calculation device 152 and the direction indication signal T_s.

For example, the light reduction pattern output device 153 may generate the light pattern information P_inf that reduces a light irradiation distance and a light width as the code value of the distance information D_inf increases.

The light reduction pattern output device 153 may generate the light pattern information P_inf that increases the light irradiation distance and the light width as the code value of the distance information D_inf decreases.

At this time, the light reduction pattern output device 153 may generate the light pattern information P_inf that increases the left or right light width of the light pattern depending on the direction indication signal T_s, while changing the light irradiation distance and the light width depending on the distance information D_inf.

The light concentration pattern output device 154 may generate the light pattern information P_inf based on the object detection signal O_d of the object determination device 151.

For example, when the object detection signal O_d is disabled, the light concentration pattern output device 154 may generate light pattern information P_inf for maximally increasing the light irradiation distance and minimally decreasing the light width.

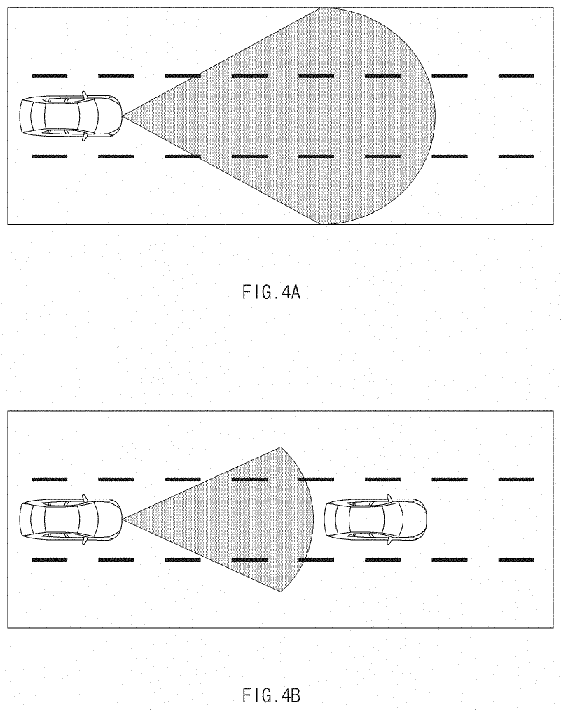

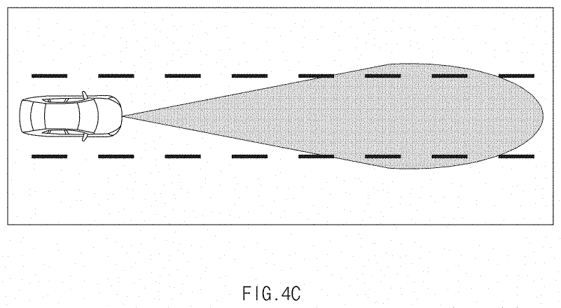

The operation of a lamp control apparatus for a vehicle according to an embodiment of the present disclosure implemented as described above will be described with reference to FIG. 4 as follows.

In the case of driver driving in which a driver directly drives a vehicle, the driving mode selection signal S_s may be disabled.

When the driving mode selection signal S_s is disabled, the selection device 110 may disable the pattern selection signal P_s.

When the pattern selection signal P_s is disabled, the first light pattern output device 140 may be activated, and the second light pattern output device 150 may be deactivated.

The activated first light pattern output device 140 may generate the light pattern information P_inf for emitting a light pattern as illustrated in FIG. 4A onto a road at the predetermined light irradiation distance and light width.

At this time, the activated first light pattern output device 140 may generate the light pattern information P_inf for increasing the left or right light width of the light pattern depending on the direction indication signal T_s.

In the case of semi-autonomous driving or autonomous driving in which a driver does not directly drive a vehicle, the driving mode selection signal S_s may be enabled.

When the driving mode selection signal S_s is enabled, the selection device 110 may enable the pattern selection signal P_s.

When the pattern selection signal P_s is enabled, the first light pattern output device 140 may be deactivated, and the second light pattern output device 150 may be activated.

The activated second light pattern output device 150 may detect a preceding vehicle that is driving on the host lane within a predetermined distance.

The activated second light pattern output device 150 may generate the light pattern information P_inf for changing the light irradiation distance and light width depending on the distance to the preceding vehicle. At this time, as illustrated in FIG. 4B, the activated second light pattern output device 150 may generate light pattern information P_inf for reducing the light irradiation distance and light width as the distance to the preceding vehicle is shorter. Moreover, the activated second light pattern output device 150 may generate the light pattern information P_inf for increasing the left or right light width of the light pattern depending on the direction indication signal T_s.

As illustrated in FIGS. 4A and 4B, the activated second light pattern output device 150 may generate the light pattern information P_inf for reducing the light irradiation distance and light width more than the light pattern information P_inf output by the activated first light pattern output device 140.

When the activated second light pattern output device 150 does not detect a preceding vehicle on the host lane within a predetermined distance, the activated second light pattern output device 150 may generate the light pattern information P_inf for forming a light pattern with a maximum light irradiation distance and a minimum light width as illustrated in FIG. 4C.

As such, when there is a preceding vehicle on the host lane during semi-autonomous driving or autonomous driving, the lamp control apparatus for a vehicle according to an embodiment of the present disclosure may change the light irradiation distance and light width depending on the distance to the preceding vehicle, thereby reducing the power consumption of the lamp without dazzling the driver of the preceding vehicle. Moreover, when there is no preceding vehicle on the host lane during semi-autonomous driving or autonomous driving, the lamp control apparatus for a vehicle according to an embodiment of the present disclosure may form a light pattern having the maximum light irradiation distance and the minimum light width, thereby enhancing long-distance visibility through light concentration while reducing the power consumption of a lamp.

Besides, the lamp control apparatus for a vehicle according to an embodiment of the present disclosure may control a lamp using sensors used during semi-autonomous driving or autonomous driving, thereby implementing a lamp control apparatus for a vehicle according to an embodiment of the present disclosure without increasing the number of parts.

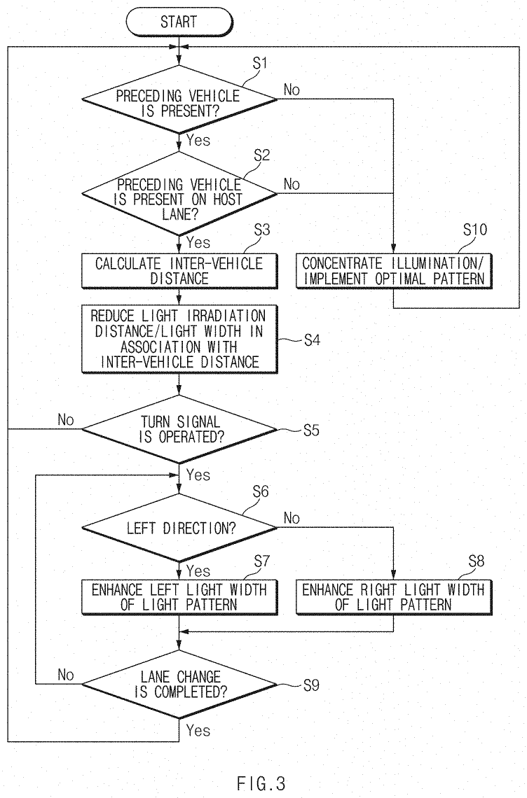

FIG. 3 is a flowchart illustrating an operation of a lamp control apparatus for a vehicle according to an embodiment of the present disclosure.

At this time, FIG. 3 may be a flowchart of an operating method of a lamp control apparatus for a vehicle operating during semi-autonomous driving or autonomous driving.

The lamp control apparatus for a vehicle may detect whether there is a preceding vehicle within a predetermined distance based on image information or distance information included in the object information O_inf (S1).

When the preceding vehicle is not detected (No), as illustrated in FIG. 4C, the lamp control apparatus for a vehicle may form a light pattern for enhancing a driver's visibility by concentrating the illumination having the minimum light width and the maximum light irradiation distance (S10). Afterward, the lamp control apparatus for a vehicle may again detect whether there is a preceding vehicle (S1).

On the other hand, when the preceding vehicle is detected (Yes), the lamp control apparatus for a vehicle may determine whether the detected preceding vehicle is driving on the host lane, based on the object information O_inf (S2).

When the preceding vehicle is not driving on the host lane (No), as illustrated in FIG. 4C, the lamp control apparatus for a vehicle may form a light pattern for enhancing a driver's visibility by concentrating the illumination having the minimum light width and the maximum light irradiation distance (S10). Afterward, the lamp control apparatus for a vehicle may again detect whether there is a preceding vehicle (S1).

On the other hand, when the preceding vehicle is driving on the host lane (Yes), the lamp control apparatus for a vehicle may calculate the distance to the preceding vehicle (S3).

As the distance to the preceding vehicle is shorter, the lamp control apparatus for a vehicle may reduce the light width and light irradiation distance of the light pattern emitted onto a road (S4).

At this time, when the direction indication signal T_s is enabled or disabled, the lamp control apparatus for a vehicle may detect whether the turn signal is operated (S5).

When the turn signal is not operated (No), the lamp control apparatus for a vehicle may again detect whether there is a preceding vehicle (S1).

On the other hand, when the operation of the turn signal is detected (Yes), the lamp control apparatus for a vehicle may detect whether the direction indication signal T_s is enabled (S6).

When the direction indication signal T_s is enabled and indicates the left side (Yes), the lamp control apparatus for a vehicle may increase the left light width of the light pattern (S7).

On the other hand, when the direction indication signal T_s is disabled and indicates the right side (No), the lamp control apparatus for a vehicle may increase the right light width of the light pattern (S8).

Afterward, when a lane change is completed (Yes), that is, when the turn signal is not operated, the lamp control apparatus for a vehicle may again detect whether there is a preceding vehicle (S1).

On the other hand, when the lane change is not completed (No), the lamp control apparatus for a vehicle may detect whether the direction indication signal T_s is enabled (S6), and may increase the left or right light width of the light pattern depending on the direction indication signal T_s.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

The present technology may reduce power consumption by changing the light irradiation pattern depending on a driving mode.

Furthermore, when there is a preceding vehicle during ADAS driving or autonomous driving, the present technology may change a light irradiation distance and a light width depending on the distance to the preceding vehicle, thereby reducing power consumption and preventing the driver of the preceding vehicle from glaring.

Moreover, when there is no preceding vehicle during ADAS driving or autonomous driving, the present technology may enhance long-distance visibility through light concentration that increases the light irradiation distance while a light width is reduced.

In addition, the present technology may be implemented without increasing the number of parts, using sensors used during ADAS driving or autonomous driving.

Besides, a variety of effects directly or indirectly understood through the specification may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A lamp control apparatus for a vehicle, the apparatus comprising:
an object detection device configured to detect an object at a periphery of the vehicle to output the detection result as object information; and
a light pattern output device configured to determine whether a preceding vehicle driving on a host lane is present, based on the object information and to generate light pattern information for changing a light pattern depending on the determination result.

2. The apparatus of claim 1, wherein the object detection device includes at least one of a camera configured to obtain an image in front of the vehicle or a sensor configured to determine a distance to the preceding vehicle.

3. The apparatus of claim 1, wherein the light pattern output device generates the light pattern information for changing a light irradiation distance and a light width of the light pattern depending on a distance to the preceding vehicle, when the preceding vehicle driving on the host lane is detected within a predetermined distance based on the object information and generates the light pattern information for forming the light pattern with the minimum light width and the maximum light irradiation distance when the preceding vehicle is not detected.

4. The apparatus of claim 3, wherein the light pattern output device generates the light pattern information for reducing the light irradiation distance and the light width as the distance to the preceding vehicle is shorter.

5. The apparatus of claim 3, wherein the light pattern output device generates the light pattern information for increasing the left or right light width of the light pattern depending on a direction indication signal when the preceding vehicle is detected.

6. The apparatus of claim 1, wherein the light pattern output device includes:
an object determination device configured to determine whether the preceding vehicle driving on the host lane is present within a predetermined distance, based on the object information;
a distance calculation device configured to calculate a distance to the preceding vehicle based on the object information when the preceding vehicle is detected;
a light reduction pattern output device configured to generate the light pattern information based on the calculated distance to the preceding vehicle and a direction indication signal; and
a light concentration pattern output device configured to generate the light pattern information for maximizing a light irradiation distance of the light pattern and minimizing a light width of the light pattern when the preceding vehicle is not detected.

7. The apparatus of claim 6, wherein the light reduction pattern output device generates the light pattern information for reducing the light irradiation distance and the light width of the light pattern as the calculated distance to the preceding vehicle is shorter, and generates the light pattern information for increasing the left or right light width of the light pattern depending on the direction indication signal.

8. A lamp control apparatus for a vehicle, the apparatus comprising:
a selection device configured to generate a pattern selection signal based on a driving mode signal;
an object detection device configured to detect an object at a periphery of the vehicle to output the detection result as object information;
a first light pattern output device configured to generate light pattern information based on the pattern selection signal; and
a second light pattern output device configured to generate the light pattern information based on the pattern selection signal and the object information.

9. The apparatus of claim 8, wherein one of the first light pattern output device and the second light pattern output device is activated depending on the pattern selection signal.

10. The apparatus of claim 8, wherein the first light pattern output device generates the light pattern information for forming a light pattern at a predetermined light irradiation distance and a predetermined light width when the pattern selection signal is disabled.

11. The apparatus of claim 8, wherein the second light pattern output device determines whether there is a preceding vehicle, based on the object information and changes the light pattern information depending on a distance to the preceding vehicle when the pattern selection signal is enabled.

12. The apparatus of claim 11, wherein the preceding vehicle is a vehicle driving on a host lane within a predetermined distance.

13. The apparatus of claim 11, wherein the second light pattern output device generates the light pattern information for reducing a light irradiation distance and a light width of a light pattern as a distance to the preceding vehicle is shorter, and generates the light pattern information for forming the light pattern with the minimum light width and the maximum light irradiation distance when the preceding vehicle is not present.

14. The apparatus of claim 11, wherein the second light pattern output device generates the light pattern information for increasing a left or right light width of a light pattern depending on a direction indication signal when the preceding vehicle is detected.

15. The apparatus of claim 8, wherein the second light pattern output device includes:
an object determination device configured to determine whether a preceding vehicle driving on a host lane is present within a predetermined distance, based on the object information;
a distance calculation device configured to calculate a distance to the preceding vehicle based on the object information when the preceding vehicle is detected;
a light reduction pattern output device configured to generate the light pattern information based on the calculated distance to the preceding vehicle and a direction indication signal; and
a light concentration pattern output device configured to generate the light pattern information for maximizing a light irradiation distance and minimizing a light width when the preceding vehicle is not detected.
